(19) United States
(12) Patent Application Publication
(10) Pub. No.: US 2025/0046903 A1
(43) Pub. Date: Feb. 6, 2025

(54) CONNECTOR CLAMP FOR TERMINALS OF BATTERY-BLOCK CELLS

(71) Applicants: Michael SAKOWICZ, Wien (AT); Philipp THONET-DRECHSEL, Wien (AT)

(72) Inventors: Michael SAKOWICZ, Wien (AT); Philipp THONET-DRECHSEL, Wien (AT)

(21) Appl. No.: 18/714,902

(22) PCT Filed: Dec. 6, 2022
(86) PCT No.: PCT/AT2022/060431

§ 371 Date: Jun. 13, 2024

(30) Foreign Application Priority Data
Dec. 6, 2021 (AT) A50972/2021

(51) Int. Cl. H01M 10/613; H01M 10/653; H01M 10/6551; H01M 10/6556; H01M 10/6557; H01M 50/296; H01M 50/503; H01M 50/505; H01M 50/517; H01M 50/526

(52) U.S. Cl. CPC H01M 10/613; H01M 10/653; H01M 10/6551; H01M 10/6556; H01M 10/6557; H01M 50/296; H01M 50/503; H01M 50/505; H01M 50/517; H01M 50/526

(57) ABSTRACT

The invention relates to a connecting terminal (1) for arresters (5) of cells (6) of a battery block, comprising a bus bar (+) with at least two recesses into which a respective trapezoidal wedge-type body (2) is inserted. The wedge-type bodies (2) are inserted into the bus bar (4) with the shorter parallel side of the trapezoid in front, and two respective arresters (5) can be securely clamped between each wedge-type body (2) and the bus bar (4) in two clamping regions. The wedge-type bodies (2) are pressed against the bus bar (4) with clamping screws (3). The bus bar (4) is formed as a single piece from a material with high electrical conductivity. According to the invention, a cooling channel (7) is provided in the bus bar (4) between two recesses, through which a coolant can flow, such that the bus bar (4) is simultaneously a cooling element (+) for the battery block. Alternatively, the bus bar (4′) can be flat and elongated, wherein two respective contact surfaces are provided at both ends of the bus bar (4′), lying symmetrically relative to the longitudinal axis, and the arresters are clamped between these contact surfaces and strip-shaped clamping elements (2′) with clamping screws (3). In this way, one bus bar (4, 4′) can cool up to four arresters (5).

### FIELD OF THE INVENTION

The present invention relates to a connection terminal for a power supply, namely an anode or cathode connection terminal for a battery or cells of a battery block, comprising a busbar with at least four contact surfaces, a respective terminal clampable between each contact surface and a respective clamping element, and clamping elements, in particular clamping screws, that press the clamping elements against the contact surfaces of the busbar, the busbar being formed from a material with high electrical conductivity and of one-layer design.

### STATE OF THE ART

Such connection terminals made of according to US 2020/0411831 and are used in electric vehicles in particular. The busbar contains two recesses, into each of which a wedge is inserted. This allows four terminals to be connected together so that two cells connected in parallel can be connected in series with two other cells connected in parallel, as illustrated in particular in FIG. 3 of this document. However, no cooling is described in this document.

A similar system is known from WO 2012/069209 where there is only one recess in each busbar, so that all cells must be connected in series. On page 7, last paragraph of this document, it is explicitly mentioned that all cells are electrically connected in series; each wedge thus connects an anode conductor of one cell with the cathode conductor of the next cell. According to this document (page 7, middle paragraph), each wedge has a cooling passage through which a cooling liquid flows.

The disadvantage of this system is that each cooling passage requires two connections (for supplying and supply and removal of coolant) and the same number of cells as wedges are provided (see FIG. 3 and page 8, last full paragraph). This means that two coolant connections are required per cell.

### OBJECT OF THE INVENTION

It is the object of the present invention to provide a solution of high-quality current and heat transfer and that is easier to make with cells connected in parallel.

This object is attained by a connection terminal of the type described above by providing at least one cooling passage in the busbar through which a cooling fluid can flow, so that the busbar is simultaneously a cooling element for the battery block.

The four contact surfaces can be formed in two different ways:

On the one hand, analogous to above-cited US 2020/0411831 it is possible that two contact surfaces are formed by a recess in the busbar, into each of which is fitted a respective wedge that serves as a clamping element, the wedges are of trapezoidal cross-section, and the recesses are of complementary trapezoidal cross-section, the wedges being fitted into the busbar with the shorter parallel base of the trapezoid innermost. The advantage here is that the arrangement is self-locking with a corresponding wedge angle, i.e. even if the clamping elements, in particular clamping screws, loosen, secure contact is maintained. As a result of the wedges, however, a relatively large overall height is required.

If a lower overall height is needed, it can alternatively be provided that the busbar is flat and extends along a longitudinal axis, that each end of the busbar has two contact surfaces that are symmetrical to the longitudinal axis, and that the clamping elements are strip-shaped.

The design as a busbar allows the cathode terminals or the anode terminals of several anode terminals of several cells of the battery pack to be connected together (parallel connection). The solution presented is therefore scalable for different power ranges. Typically, two to five cells are connected in parallel for higher current.

In the design with wedges, the busbars can correspondingly have two to five recesses for wedges: For example, with three cells connected in parallel, six poles must be connected together, three positive poles of one group of cells connected in parallel and three negative poles of the next group of cells connected in parallel, and two poles are connected together by each wedge. This solution enables a fast-charging system in which 60 to 80% of a full charge is absorbed within five minutes.

However, waste heat of 30-40 W is released per cell, so that with 1000 cells, 30 to 40 kW of heat must be dissipated immediately at a low temperature level and without hidden heat build-up. Even with higher power extraction, waste heat is generated and must also be removed at a low temperature.

To make this possible, a cooling passage is provided in the busbar between two recesses; if more than two recesses are provided, a cooling passage is expediently provided between every two recesses. This arrangement has the advantage that the space between the recesses, which according to the above-cited US 2020411831 remains unused, is utilized for the cooling passages, so that not, as for example suggested in DE 102014001975 must the cooling ducts be installed above the busbar where they take up valuable space. In addition, one cooling passage cools up to four terminals, so that fewer cooling passages are needed than according to the above-cited WO 2012/069209.

In the embodiment with a flat busbar, two cells can be connected in parallel as two contact surfaces are provided at both ends. However, three or four cells can also be connected in parallel because two cells can be clamped back to back with their terminals adjacent to each other between a contact surface and the respective clamping element.

It is useful to improve the current transfer if the clamping areas of the busbar are provided with an electrically conductive layer, preferably of graphite and/or copper, that is also thermally conductive to improve the heat transfer. On the one hand, this reduces electrical contact resistance and thus also the waste heat and, more importantly, it also reduces heat transfer resistance. Even with high-quality production, the contact surfaces themselves have small air gaps that hinder heat transfer more than current transfer. By coating the contact surfaces with a mixture of graphite and very fine copper dust, as a lightly pressed plate or as a paste, it is possible to achieve a significant improvement in both the heat transfer and the current transfer; and the lower the thermal resistance from the inside of the cell of the battery block to the cooling fluid, the cooler the inside of the cell is for a given power to be dissipated and a given temperature of the cooling fluid.

For the purpose of corrosion protection, it is favorable if the busbar and/or the clamping elements are at least partially coated with silver or nickel. As these metals also conduct electricity and heat very well, the contact surfaces can also be coated with them as an alternative to the above-described mixture of graphite and copper dust.

Especially if the busbar is manufactured using 3D printing, with the help of which almost any shape can be produced, it is also possible to provide several cooling passages in a busbar, and to connect together these cooling passages within the busbar. In this way, two connections for cooling fluid are sufficient to cool six or even ten terminals, for example. This significantly reduces the effort required for the cooling passage connections.

It is expedient if the cooling passage or cooling passages of the cooling element to be provided with ribs, fins or the like. This reduces the thermal resistance between the metal of the cooling element and the cooling fluid because the corresponding surface area is increased. This is particularly useful if (as explained below) the inner surface of the cooling passage is electrically insulated.

If the cooling passage is not electrically insulated, the coolant must be nonconductive when (as is usually the case) either contacts at different electrical potentials are to be cooled with the same coolant or the heat exchanger must not be at the potential of the contacts for safety reasons and itself has no insulation from the coolant. However, this leads to a phenomenon that has received too little attention to date: with liquid cooling, residual conductivity must be expected, simply due to the separation of metal ions from the conductors and the heat exchangers. The high voltage causes problems that result in corrosion from the inside.

According to one embodiment of the invention, it is therefore provided that the cooling passage or passages are lined with an electrically insulating coating. In this way, ceramic, for example, can be used as an insulating material and there is no risk of it breaking because it is present inside the cooling element and is thus protected from mechanical stresses. Such a coating can also be applied to the outer surfaces of the busbar in the same operation if electrical insulation is required there. The busbar is preferably made mainly of aluminum.

If, in addition, the connection for the cooling fluid is made of an electrically insulating material, the cooling fluid is completely insulated, so it does not have to be a nonconductive fluid, and there is no risk of corrosion from the inside.

Various proposals have already been made for applying the coatings. In DD 301925 [U.S. Pat. No. 5,043,182] and the very similar DD 300725, for example, a porous ceramic is produced that is infiltrated with a molten metal, whereby a gradient of concentration is achieved. DE 102012200654 describes a slurry that is suitable for coating machine components, for example.

To improve the adhesion between the electrically insulating coating and the metal of the cooling element, the metal can be porous. However, the metal can also have areas (particularly on the outside) that are dense, or be dense overall.

The electrically insulating coating can be a water-based slurry, a silicone material or a polymer, in particular a polyester or a polyurethane and it may be provided with fillers that may consist of ceramic particles, quartz sands or titanium-oxide particles. The fillers may also contain fibers that preferably consist of electrically nonconductive polymers.

The use of mineral substances, such as quartz powder or titanium dioxide, as a filler serves to increase the thermal conductivity, which is particularly advantageous when using plastics as a coating. This filler can be supported by polymer fibers, where the fibers have the task of delaying rapid erosion of the coating from the surfaces and thus achieving a greater thickness if this is necessary or desired for high electrical insulation.

Slips are usually used in the ceramics industry as inorganic adhesives for raw clay parts. Slips consist of the same material as the clay parts, only the water content is so high that a viscous mass is created. In the mass production of porcelain parts, slip is used for vacuum-casting processes in order to produce uniform products in series. In the present development, the slurry is used to achieve a seal or to produce an electrically insulating coating on a metal part. Slurries are very dense, but must be fired at high temperatures. They bond very well with metal oxides. Connections made of industrial ceramic tubes for conducting cooling fluids can be installed very well with slurry as an inorganic adhesive.

Other coating compositions can be found in the broad group of polymers. The following groups are examples of many polymers that have similar properties: Polyesters and the special group of polyurethanes are characterized by high elasticity and tensile strength. The raw material is liquid and is cross-linked by a cross-linking agent and/or heat. The adhesive properties are good if the parts to be bonded, such as connections, are inserted before cross-linking.

Silicone casting compounds or silicones have similar properties. They are processed with crosslinkers in a similar way to polyurethanes and are very good electrical insulators. The adhesive properties can vary greatly depending on the product.

All coatings should be applied to the component under slight pressure. The porosity of the carrier material allows air to escape and all interior surfaces to be safely coated.

Furthermore, it is expedient if the connection for the cooling fluid consists of an electrically insulating material. If such a connection, for example a pipe socket, is inserted before the coating is applied, the coating causes it to stick together and seals any gap.

If the metal of the cooling element is to be sealed, an internal coating can alternatively be applied in a coating in a vacuum. In this case, the cooling element is placed together with the coating compound in a vacuum vessel and the air is slowly removed. The coating agent can also foam up in the process because gases escape from the mass. The advantage of vacuum treatment for the coating agent alone is the avoidance of micropores that can easily occur due to gas inclusions.

A high dielectric strength of the coating is advantageous for the coating, especially the plastic, to withstand the full operating voltage of up to 1000 V.

### BRIEF DESCRIPTION OF THE DRAWINGS

The present invention is described in more detail with reference to the accompanying drawings. Therein:

FIG. 1 is a sectional view of an embodiment of the present invention;

FIG. 2 shows a connection for a cooling passage;

FIG. 3 is a top view of another embodiment;

FIG. 4 is a section through this embodiment along line IV-IV in FIG. 3; and

FIG. 5 is a view like FIG. 4, except that four cells are connected.

### WAY(S) FOR CARRYING OUT THE INVENTION

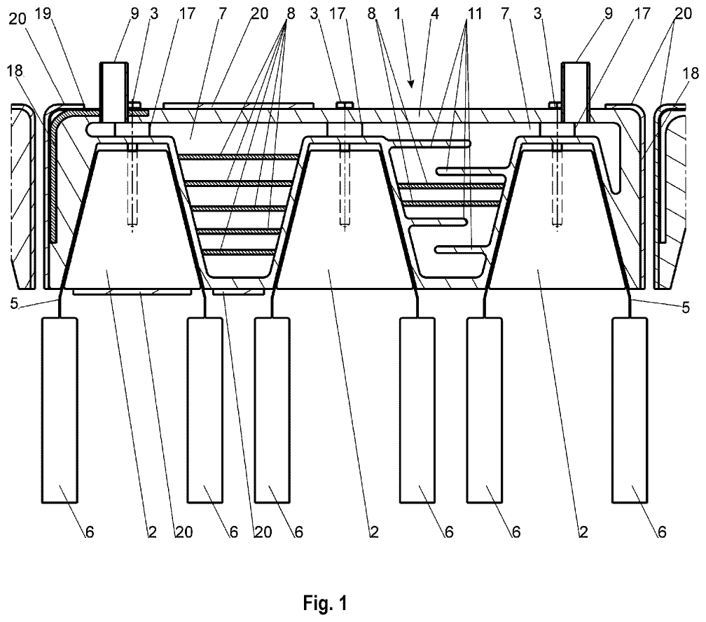

FIG. 1 shows a connection terminal 1 with three wedges 2 fitted to a busbar 4. The wedges 2 are each pressed against the busbar 4 by a clamping screw 3. Terminals 5 (electrode plates) of battery cells 6 are clamped between the wedges 2 and the busbar 4. The battery cells 6 are located below the connection terminal 1. The wedges 2 are shown in cross-section, with the clamping screw 3 in the middle.

The embodiment of the present invention shown in FIG. 1 is suitable for the parallel connection of three pouch cells: three anode terminals of one group and three cathode terminals of the next group of cells are connected together. The busbar 4 has a cooling passage 7, so it is operated as a heat sink, but the wedges 2 are not cooled. This arrangement has the advantage that narrow battery cells 6 can also be used.

The cooling passage 7 has two areas of large cross-section between the wedges 2. They are connected to each other at the top by a relatively narrow passage. It can therefore also be seen that two cooling passages are provided here, each between the recesses for the wedges 2 and connected to each other inside the busbar 4.

The cooling passage 7 has transverse webs 8 and cooling fins 11. The cooling passage 7 can be coated on the inside with an insulating material (not shown).

The clamping screws 3 extend through the cooling passage 7, and a separate support ring 17 made of the material of the busbar body transmits the forces from the clamping screw 3 into the wedge area. However, this is not absolutely necessary; the busbar can also be made of solid material around clamping screw 3, so that no measures are necessary to seal the cooling passage 7.

In the cavity of the cooling passage 7, transverse webs 8 and cooling fins 11 guide flow in order to achieve better flushing of the cooling passage 7. Of course, this arrangement of terminals can be extended for any number of battery cells 6.

The transverse webs 8 also serve to improve heat transfer from the terminals 5 (electrode plates) to the center of the busbar 4 so that the internal flow also contributes to cooling. The entire cross-section of the cooling passage 7 is therefore effective for cooling.

Additional cooling fins 11 in the vicinity of the terminals 5 (electrode plates) ensure improved heat transfer into the cooling passage 7. The transverse webs 8 or the cooling fins 11 can also be shaped in such a way that flow in the cooling passage 7 is kept turbulent. With 3D printing, it is possible to create corresponding wave shapes or slopes in the transverse webs 8 or cooling fins 11 so that flow is repeatedly deflected. It is important to ensure that the shapes do not contribute to the formation of air bubbles, as these would massively impede heat transfer.

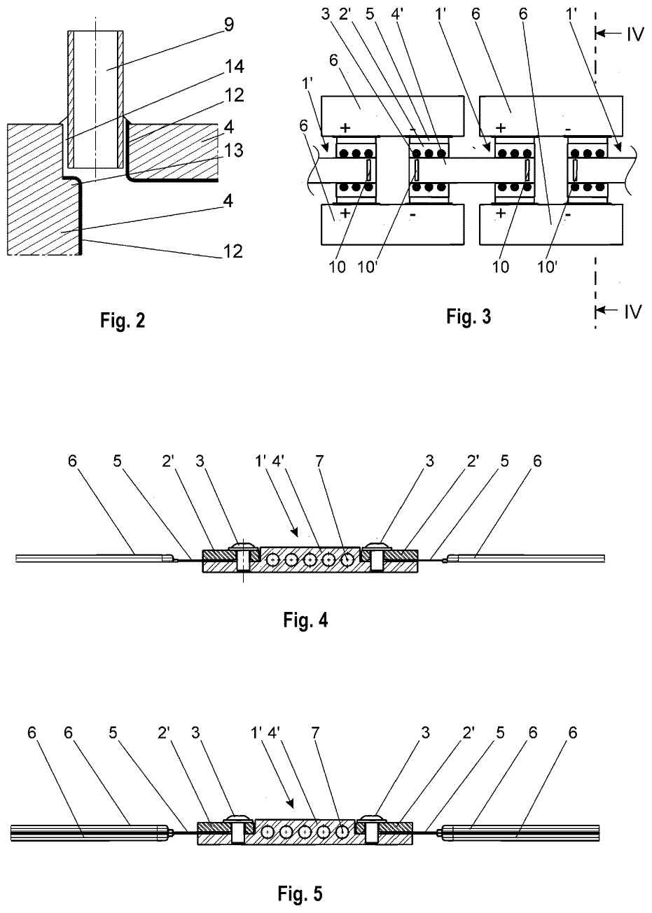

Compared to a simple bore, this design of the cooling passages 7 can provide a cooling-effective surface between the busbar 4 and the unspecified cooling fluid in the cooling passages 7 that is increased by a factor of 3 to 5 compared to a simple bore. This more than compensates for the higher thermal resistance of a coating 12 (see FIG. 2). The coating 12 is applied in a constant thickness over the entire inner surface of the cooling passage 7 (see FIG. 1).

The cooling element can be manufactured using 3D printing, for example. Despite complex geometry with cooling fins 11 and transverse webs 8 on the inside, 3D printing can make production possible.

With 3D printing, it is possible to produce a porous, metallic object. This porosity is very advantageous if the inside surface of the object is coated with an electrically insulating coating. Porous means that a gas, such as air, can diffuse through the structure. If a sealing and/or insulating substance fills spaces of the finished printed cooling element, air can escape from the spaces through the pores. This means that air escapes automatically everywhere, even if only a slight overpressure is applied, and no bubbles remain that would cause weak points.

The pores themselves, on the other hand, are so small that viscous substances such as slurries or rubber-like mixtures do not penetrate deeply. However, the interlocking between the materials is sufficient to achieve a stable coating inside the cavities.

This method achieves three main objectives:
Cooling the batteries via the terminals
Reliable sealing of all cavities
an electrically effective barrier against any coolant

The coating 12 can also be produced by impregnation, in particular by impregnation under pressure, or by a spraying process.

In order to improve the heat dissipation from the side surfaces 18 of the busbar 4, a heat pipe 19 is provided on the outside. Heat pipes have the advantage that they conduct heat up to 1000 times better than copper and can therefore also transfer small temperature differences. In reverse operation to warm up the cells in winter, the heat pipe does not interfere because it only transports a small amount of heat downward. Modern heat pipes can be clamped or inserted into a passage to transport the heat.

Pouches with very high voltages and currents are used in electromobility. It is therefore obvious to provide the connection terminals in general with lateral insulating layers 20 so that no catastrophic faulty connections can occur in the event of operating errors during assembly, etc. The spacings between adjacent connection terminals 1 are only a few millimeters, and any displacement or a part falling into the gap can cause an uncontrollable short circuit. These insulating layers 20 can be applied at all points of the terminal system, such as on the surface of the wedges 2 and the surfaces of the busbar 4, in order to generally increase safety. Of course, the contact surfaces for current transmission remain free.

FIG. 2 shows a connection for the cooling fluid circulating in the cooling passages 7. The cooling fluid is supplied and discharged via pipes 9. The pipe 9 sits on a shoulder 13 that prevents it from being pushed in too deep. The pipe 9 is made of an electrically insulating material that can be easily bonded to the respective coating 12, such as ceramic, glass, PVC and similar materials. The tubes 9 can also be made from the materials of the coating in order to achieve good adhesion. The tube 9 is inserted before coating so that the gap 14 between the wedge 2 and the tube 9 is securely filled with the coating 12. (In FIG. 2, the gap 14 on the left is not yet filled).

The cooling fluid can be supplied or discharged via hoses, but also via fluid distribution rails with elastic seals.

FIGS. 3 and 4 show another embodiment. Four battery cells 6 are shown here. The positive poles of the two right-hand battery cells 6 and the negative poles of the two left-hand battery cells 6 are attached to one and the same connection terminal 1′, namely to the middle connection terminal 1′, i.e. they are conductively connected to one another. This means that two parallel-connected battery cells 6 (shown on the right) are connected in series with two neighboring parallel-connected battery cells 6 (shown on the left). This series connection is continued to the left and right, i.e. the positive terminal of the two left-hand battery cells 6 is connected to a further, only partially shown connection terminal 1′ (the left-hand connection terminal 1′), to which the negative terminals of the next two unillustrated battery cells 6 are connected, and so on.

The connection between the terminals 5 of the battery cells 6 and the connection terminal 1′ can be seen in FIG. 4. The terminals 5 each rest on a contact surface of the busbar 4′, and a clamping element 2′ with a clamping screw 3 is pretensioned against the respective terminal 5 from the opposite side. Between the contact surfaces of the busbar 4′, the busbar 4′ has cooling passages 7, five cooling passages 7 in this example. A common supply opening 10 (see FIG. 3) is provided for supplying the cooling fluid, and a common discharge opening 10′ is provided for discharging it. In this example, four battery cells 6 are therefore cooled with one connection terminal, i.e. only one supply line and only one discharge line for cooling fluid, but only via one of the two terminals 5 in each case. On average, one busbar 4′ is used for two battery cells 6.

If four battery cells 6 are to be connected in parallel, it is possible according to FIG. 5 to do this done quite simply by arranging two battery cells 6 back to back so that their terminals 5 are in contact with each other. These adjacent terminals 5 are then clamped together between the contact surfaces of the busbar 4′ and the clamping element 2′. In this case, as many as eight battery cells 6 are cooled by a single busbar 4′.

If the terminals 5 of the battery cells 6 are arranged in such a way that they do not lie against each other when two battery cells 6 lie back to back, then, unlike in FIG. 5, a contact surface can be provided above and below the busbar 4′ and a clamping element 2′ can be provided both above and below the busbar 4′. The terminals 5 are then spaced apart by the thickness of the busbar 4′.

1. A connection terminal for anode and/or cathode terminals of cells of a battery pack, the terminal comprising
a one-layer busbar with at least two pairs of contact surfaces,
respective clamping elements juxtaposed with the contact surfaces,
respective terminals clampable between the contact surfaces and the respective clamping elements,
clamping screws, pressing the clamping elements against the contact surfaces of the busbar, the busbar being formed from a material with high electrical conductivity; and
at least one cooling passage formed in the busbar and through which a cooling fluid can flow so that the busbar is also a cooling element for the battery block.

2. The connection terminal according to claim 1, wherein each pair of contact surfaces is formed in the busbar by a respective recess into which fits a respective wedge that serves as the respective clamping element, the wedges being trapezoidal in cross-section and the recesses being of complementary trapezoidal shape in cross-section, the wedges fitting into the busbar with a shorter base of the trapezoid innermost and the cooling passage between two recesses.

3. The connection terminal according to claim 1, wherein the busbar is flat and extends along a longitudinal axis and has at each end of the busbar the respective pair of contact surfaces symmetrically flanking the longitudinal axis, the clamping elements being strip-shaped.

4. The connection terminal according to claim 1, further comprising:
clamping regions of the busbar are provided with an electrically conductive layer to improve current transfer, the layer being also thermally conductive to improve heat transfer.

5. The connection terminal according to claim 1, wherein the busbar and/or the clamping elements are at least partially coated with silver or nickel.

6. The connection terminal according to claim 1, wherein the busbar has a plurality of the cooling passages that are interconnected within the busbar.

7. The connection terminal according to further comprising:
webs, ribs, or fins in the cooling passage or in the cooling passages of the cooling element.

8. The connection terminal according to claim 1, wherein the cooling passage is lined with an electrically insulating coating.

9. The connection terminal according to claim 8, wherein material forming the busbar is porous.

10. The connection terminal according to claim 8, wherein the electrically insulating coating is a water-based slurry, a silicone material or a polyester or a polyurethane.

11. The connection terminal according to claim 8, wherein the electrically insulating coating is provided with fillers.

12. The connection terminal according to claim 11, wherein the fillers consist of ceramic particles, quartz sands or titanium-oxide particles.

13. The connection terminal according to claim 11, wherein the fillers contain fibers.

14. The connection terminal according to claim 13, wherein the fibers consist of electrically nonconductive polymers.

15. The connection terminal according to claim 1, further comprising:
a connection for the cooling fluid consists and consisting of an electrically insulating material.
